(19) United States
(12) Patent Application Publication
(10) Pub. No.: US 2008/0147475 A1
(43) Pub. Date: Jun. 19, 2008

(54) STATE OF THE SHELF ANALYSIS WITH VIRTUAL REALITY TOOLS

(76) Inventor: Matthew Gruttadauria, Yarmouthport, MA (US)

Correspondence Address: PATTERSON & SHERIDAN, L.L.P.;ATTN: GERO G. MCCLELLAN / KIMBERLY-CLARK, 3040 POST OAK BLVD., SUITE 1500, HOUSTON, TX, 77056, US

(21) Appl. No.: 11/611,590

(22) Filed: Dec. 15, 2006

(51) Int. Cl. G06Q 10/00; G06Q 20/00; G06F 17/30

(52) U.S. Cl. 705/10; 705/28; 705/22

(57) ABSTRACT

A method and apparatus for performing a state-of-the-shelf analysis using virtual reality tools is disclosed. A state-of-the-shelf virtual reality simulation may be generated by specifying a layout for the shelf-space and a time period for the virtual reality simulation, obtaining sales data for the items stored in the shelf-space. The state-of-the-shelf virtual reality simulation provides a visualization of changes to the shelf-space based on the sales rate data as changes occur over the specified time-period.

### BACKGROUND OF THE INVENTION

1. Field of the Invention

Embodiments of the present invention generally relate to virtual reality simulations generated using computer software. More specifically, embodiments of the invention relate to a state-of-the-shelf analysis generated with virtual reality tools.

2. Description of the Related Art

The retail sale of consumer products is highly competitive, and consumer product manufacturers spend enormous sums on advertising to promote their products. Less visible to the typical consumer, however, is the competition for retail product space on the shelves of a retail location. In addition to competing for consumer attention and brand loyalty, product manufacturers compete with one another for shelf-space at point-of-sale locations, which can range from small single store operations to large global retailers that operate hundreds, or in some cases thousands, of stores.

For the retailer, of course, the overall goal is to maximize sales without having to store and manage excess inventory for a given product. An “out of stock” event can lead to lost sales; at the same time, shelf space is limited, as is the ability to store products in excess of what may be placed on the retail shelf. Thus, from the retailer's point of view, optimizing shelf space is of great importance. A number of competing concerns may guide a retailer in deciding whether, and how much, shelf space to dedicate to any given product. For example, historical sales rates, anticipated sales rates, a desired product assortment, subjective impressions of product popularity, and a need to reserve space for “in-house” brands may all contribute to a decision about how much shelf space a given product will have. Critical to these decisions, however, is an understanding of a product sale rate and the relationship of that rate to the amount and type of shelf-space dedicated to that product. As a general rule, deciding to give more shelf space to one product (at the expense of others) will lead to greater sales of that product. Such a decision may be based on a sales-rate for a product at a single retail location, or may be based on a combined sales rate for multiple stores. Factors such as the availability and schedule for product deliveries, manufacturer incentives and promotions, the availability and time for employees to check and stock shelves as needed may also contribute to shelf-space decisions.

Currently, sophisticated point-of-sale systems can provide retailers with a wealth of information to use in making self-space decisions. Similarly, developing technologies such as RFID tags and other “smart shelf” technology may provide retailers with even more information. However, interpreting this information to understand the “state-of-the-shelf” at any given moment has proven to be difficult. While point-of-sale data can provide retailers with a great deal of information, this information is typically presented as spreadsheets and summaries of sales data and as an aggregate sales-rate for a given product at one or more retail locations. Interpreting this type of sales data often results in errant shelf-space decisions. For example, consider point-of-sale data indicating that over a given weekend (Friday-Sunday), a store sold 30 units of a particular consumer product, leading to a sales-per-day rate 30/3, or 10 units per day. However, if the shelf actually ran out of the product at noon on Sunday, and no scheduled stocking occurred until after a delivery on Monday, sales were likely lost. In such case, the out-of-stock event is difficult to discern from the available sales data. Thus, even if sales of the product lead in its category (which may be why it ran out of stock on Sunday), its sales data may not reflect lost opportunity. Thus, even what may appear to be strong sales data for a given product may in fact, be reflective of weak sales, relative to possible sales in a properly stocked environment. Many other scenarios lead to similar results. In these cases, a product manufacturer may be unable to convince a retailer to give more space to a product, even when doing so could increase overall sales. This example demonstrates that relying on point-of-sale data alone requires a retailer (or product manufacturer with access to the sale data) to analyze, interpret, and in some cases simply guess, as to what is the state-of-the-shelf for any given moment.

One approach to gathering more accurate state-of-the-shelf data has been to use in-store video or having store (or product manufacturer) personnel manually observe the shelf space for a given product over some period of time. While this approach may help identify an out-of-stock event, or other problems at a particular retail location, it does so only at the great expense of manually monitoring shelf-state on a product by product basis. Doing so is clearly an unacceptable solution, even when used for a single retail location. Further, this approach fails when trying to generate a composite or average state-of-the-shelf analysis for multiple retail locations that use the same shelf and product layouts.

Moreover, out-of-stock events are not limited to the retail grocer scenarios discussed above. Instead, out-of-stock events may occur in many other situations. For example, consider a supply room of a hospital stocked with commonly needed items, office environments using a shared supply room, or other retail environments with a supply of inventory to sell from a shelf (or other display). In each case, a product sales rate, i.e., a rate at which a given item is removed from a shelf as reflected in point-of-sale or inventory consumption data, may not alone provide an accurate view of the state-of-the-self for any given movement, making out-of-stock events difficult to identify.

Accordingly, there is a need for techniques to provide a state-of-the-shelf analysis that conveys the state of the shelf as it changes over time.

### SUMMARY OF THE INVENTION

The present invention generally provides a virtual reality tool configured to provide an accurate visualization of a “state-of-the-shelf” for a given product or item. Embodiments of the invention include a method of generating a virtual reality simulation of a state of a shelf-space. The method generally includes generating a state-of-the-shelf virtual reality simulation for a given layout of the shelf-space based on sales rate data indicating when purchasable items stored in the shelf-space are removed from the shelf-space during a specified time period. The layout may define a selection and arrangement for a set of one or more of the purchasable items stored in the shelf-space. The state-of-the-shelf virtual reality simulation provides a visualization of changes to the shelf-space over the specified time-period based at least in part on the sales rate data.

Embodiments of the invention also include a computer readable storage medium containing a program which, when executed, performs an operation for generating a virtual reality simulation of a state of a shelf-space. The operations generally include generating a state-of-the-shelf virtual reality simulation for a given layout of the shelf-space based on sales rate data indicating when purchasable items stored in the shelf-space are removed from the shelf-space during a specified time period. The layout defines a selection and arrangement for a set of one or more of the purchasable items stored in the shelf-space. And the state-of-the-shelf virtual reality simulation may be used to provide a visualization of changes to the shelf-space over the specified time-period based at least in part on the sales rate data.

Embodiments of the invention also include a system having a computing device and a memory storing a virtual reality tool. The virtual reality tool may be configured to generate a state-of-the-shelf virtual reality simulation for a given layout of the shelf-space based on sales rate data indicating when purchasable items stored in the shelf-space are removed from the shelf-space during a specified time period. The layout defines a selection and arrangement for a set of one or more of the purchasable items stored in the shelf-space. And the state-of-the-shelf virtual reality simulation provides a visualization of changes to the shelf-space over the specified time-period based at least in part on the sales rate data.

Embodiments of the invention also include a method for a product manufacturer to manage a relationship with a retailer selling one or more products manufactured by the product manufacturer. This method generally includes identifying a selection of layout for a shelf-space used to display the one or more products manufactured by the product manufacturer for sale and a selection of a time period for a state-of-the-shelf virtual reality simulation. The method also includes obtaining sales rate data indicating when items stored in the shelf-space are removed from the shelf-space during the time period, and generating a state-of-the-shelf virtual reality simulation. The state-of-the-shelf virtual reality simulation provides a visualization of changes to the shelf-space based on the sales rate data as changes occur over the time-period specified for the virtual reality simulation. Once generated, the virtual reality simulation may be presented to a representative of the retailer.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating components of a computing environment and virtual reality system for conducting a state-of-the-shelf analysis, according to one embodiment of the invention.

FIG. 2 is a conceptual diagram further illustrating components of the virtual reality system first shown in FIG. 1, according to one embodiment of the invention.

FIG. 3 is a flow chart illustrating a method for conducting a state of the shelf analysis, according to one embodiment of the invention.

FIGS. 4A-4D illustrate a virtual reality simulation of the state-of-the-shelf for an exemplary shelf-pace, according to one embodiment of the invention.

### DETAILED DESCRIPTION

Embodiments of the invention employ virtual reality techniques configured to provide an virtual reality visualization of a “state-of-the-shelf” for a given product or item, as the inventory on the shelf is consumed (and, in some cases, replenished) over a period of time.

Embodiments of the invention are described herein using a retail sales shelf as an example of a state-of the-shelf virtual reality simulation. However, one of ordinary skill in the art will recognize that the virtual reality tool disclosed herein may be adapted for use with a variety of “shelf-spaces” where out-of-stock events may occur, or where a state-of-the-shelf analysis could lead to a better distribution or organization of limited resources. For example, “shelf-spaces” maintained by a supply room of a hospital stocked with commonly needed items, office environments using a shared supply room, or other retail environments with a supply of inventory to sell, may be used as the basis for a state-of-the-shelf virtual reality simulation. In such cases, a rate at which items are removed from a shelf-space in one of these environments may be depicted in the VR simulation.

Further, the following description references embodiments of the invention. However, it should be understood that the invention is not limited to any specifically described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention is implemented as a program product for use with a computer system. The program(s) of the program product defines functions of the embodiments (including the methods described herein) and can be contained on a variety of computer-readable media. Illustrative computer-readable media include, but are not limited to: (i) non-writable storage media on which information is permanently stored (e.g., read-only memory devices within a computer such as CD-ROM or DVD-ROM disks readable by a CD-ROM or DVD-ROM drive); (ii) writable storage media on which alterable information is stored (e.g., floppy disks within a diskette drive, hard-disk drives, or flash memory devices). Other media include communications media through which information is conveyed to a computer, such as through a computer or telephone network, including wireless communications networks. The latter embodiment specifically includes transmitting information to/from the Internet and other networks. Such computer-readable media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

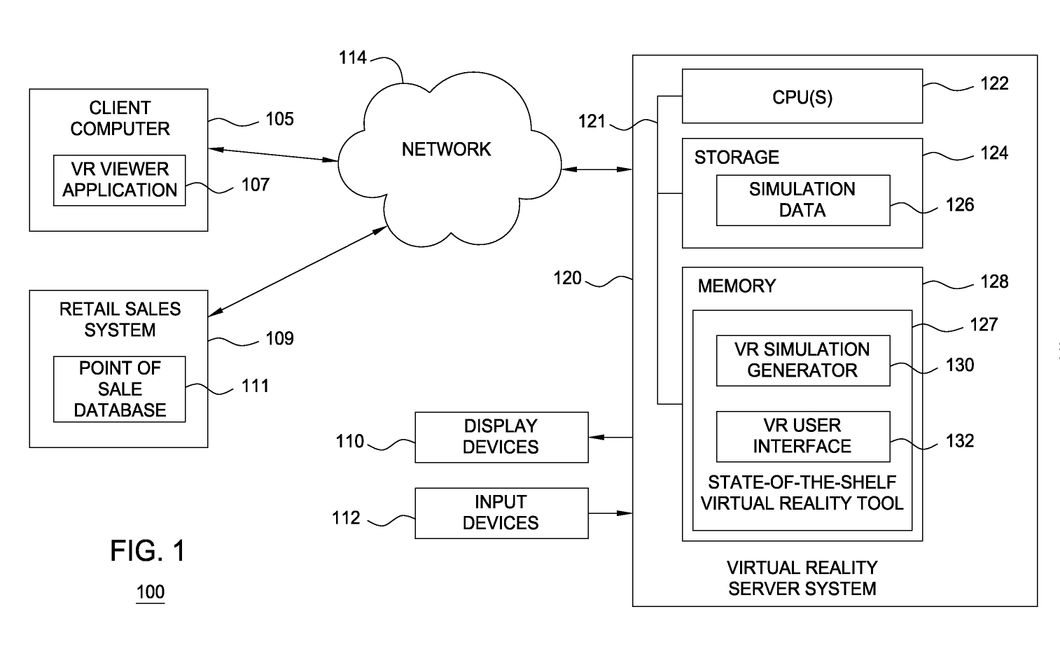

FIG. 1 is a block diagram illustrating a computing environment 100 for conducting a state-of-the-shelf analysis using virtual reality tools, according to one embodiment of the invention. As shown, computing environment 100 includes a client computer system 105 and a retail sales system 109 both configured to communicate with a virtual reality server system 120 over a network 114. The computer systems 105, 109, and 120 illustrated in environment 100 are included to be representative of existing computer systems, e.g., desktop computers, server computers, laptop computers, tablet computers and the like. However, embodiments of the invention are not limited to any particular computing system, application, device, or network architecture and instead, may be adapted to take advantage of new computing systems and platforms as they become available. Additionally, those skilled in the art will recognize that the illustration of computer systems 105,109, and 120 are simplified to highlight aspects of the present invention and that computing systems and networks typically include a variety of elements not shown in FIG. 1.

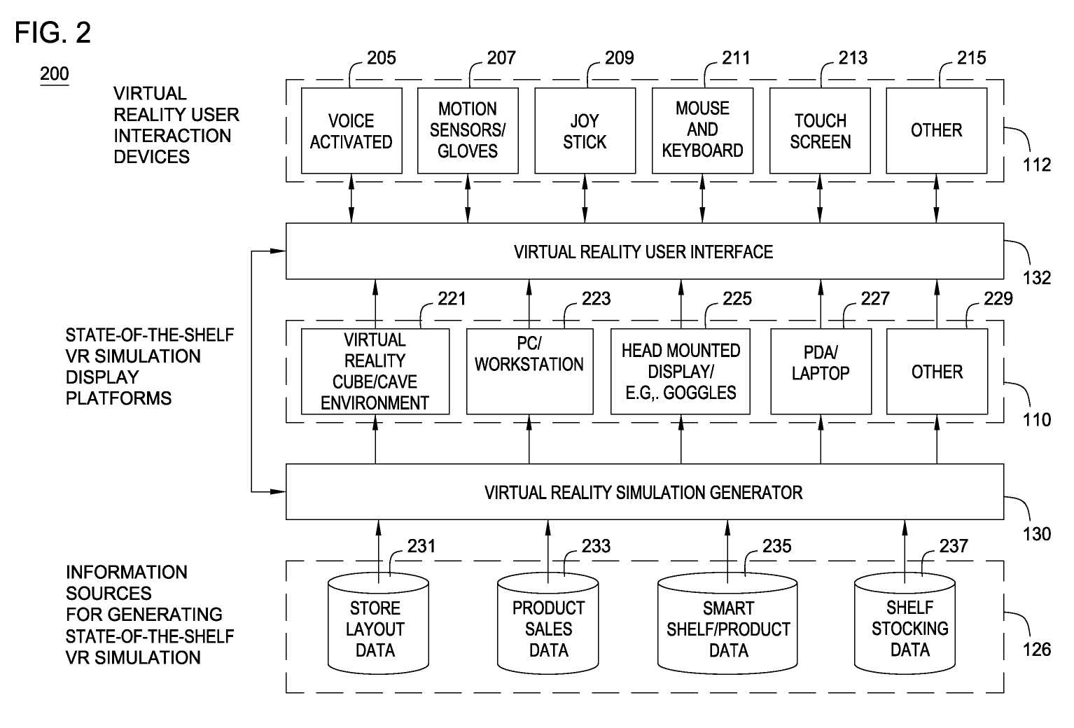

As shown, server system 120 includes one or more CPUs 122, storage 124, and memory 128 connected by a bus 121. CPU 122 is a programmable logic device that executes the instructions, logic and mathematical processing performed in executing user applications (e.g., a virtual reality tool 127). Storage 124 stores application programs and data for use by sever system 120. Common storage devices 124 include hard-disk drives, flash memory devices, optical media and the like. Additionally, the processing activity of server system 120 may be coordinated by an operating system (not shown). Well known examples of operating systems include the Windows® operating system, distributions of the Linux® operating system, among others. Network 114 represents any kind of data communications network, including both wired and wireless networks. Accordingly, network 114 is representative of both local and wide area networks, including the Internet. In one embodiment, users may access and view a state-of-the-shelf simulation generated by server system 120 using a client computer system 105 and a viewing application 107. For example, virtual reality tool 127 may be configured to generate a simulation that may be viewed over network 114 using viewing application 107. In such a case, viewing application 107 may be a web-browser configured to display multi-media content such as audio and video streams. Alternatively, users may view and interact with a state-of-the-shelf simulation using a variety of display devices 110 and input devices 112 communicating with server system 120. Examples of display devices 110 and input devices 112 are further described below in conjunction with a description of FIG. 2.

Illustratively, memory 128 of server system 120 includes state-of-the-shelf virtual reality tool 127. In one embodiment, virtual reality tool 127 is a software application that allows users to generate and display state-of-the-shelf analysis using a specified collection of simulation data 126. In one embodiment, simulation data 126 includes sales data obtained from the retail sales system 109 and the point-of-sale database 111. As shown, virtual reality tool 127 includes a simulation generator 130 and a user interface 132. The simulation generator 130 is generally configured to generate a simulation presented on display devices using the simulation data 126, and is described in more detail below. User interface 132 provides an interface to the state-of-the-shelf virtual reality tool 127.

FIG. 2 is a conceptual diagram further illustrating components of computing environment 100 first shown in FIG. 1, according to one embodiment of the invention. More specifically, FIG. 2 illustrates an exemplary collection of input devices 112, display devices 110, and simulation data 126 used to generate and present users with a state-of-the-shelf simulation. Input devices 112 allow users to interact with a state-of-the-shelf simulation through virtual reality user interface 132 in a variety of ways. As shown, input devices 112 may include a voice activated system 205, motion sensing devices 207 worn by a user, e.g., a set of motion sensing gloves, a joystick device 209, a mouse and keyboard device 211, a touch screen device 213, or other user interface device 215. Of course, depending on how a state-of-the-shelf simulation is presented to a user, the particular input devices 112 may be tailored to suit the needs in an individual case.

In various embodiments, different virtual reality display platforms may be used to present a user with a state-of-the-shelf simulation. Illustratively, FIG. 2 shows a virtual reality cube/sphere or CAVE environment 221, a PC workstation 223 and LCD or CRT monitor, a head-mounted display 225 worn by a user, a PDA or laptop computer 227 or other user virtual reality display platform 229. Additional examples of a head mounted display are described in application Ser. No. 10/435,41, filed May 9^{th}, 2003 titled “Vision System and Method for Observing Use of a Product by a Consumer.” incorporated by reference herein in its entirety. As is known, CAVE environment provides immersive virtual environment where a user may interact with a virtual reality system inside a room where projectors are directed to, e.g., three, four, five or six of the walls of a cube. The images may be in stereo requiring stereo shutter glasses to be worn. CAVE is a recursive acronym for “CAVE Automatic Virtual Environment.” Presenting a state-of-the-shelf simulation using virtual reality cube 221 may provide a user with a fully immersive visualization of a state-of-the-shelf analysis where a user's entire visual experience is provided by the virtual reality cube 221. Similarly, a head mounted display 225, such as a virtual reality helmet or 3D goggles may provide an immersive virtual environment for presenting a state-of-the-shelf analysis.

Alternatively, or additionally, a state-of-the-shelf analysis may be displayed on CRT monitors of PC workstation 223 or display screens of a PDA or laptop 227. Of course, embodiments of the invention are not limited to these virtual reality display platforms, and may be adapted for use with new ones as they become available. Further, the particular display devices 110 used to present a user with a state-of-the-shelf virtual reality simulation may be tailored to suit the needs in an individual case.

As stated, virtual reality simulation generator 130 may be configured to generate a simulation presented on display devices 110 using simulation data 126. FIG. 2 illustrates a number of exemplary data sources that may be used to supply simulation generator 130 with simulation data 126. As shown, simulation data may include store layout data 231, product sales data 233, smart/shelf product data 235, and stocking data 237.

Store layout data 231 may include a description of shelf spaces and sizes, along with a description of what products are included on each shelf. In one embodiment, store layout data 231 may be based on the actual layout used by a particular retailer. A shelf and product layout (e.g., store layout data 231) is commonly referred to as planogram. A planogram shows how and where specific retail products should be placed on shelves or displays in order to increase customer purchases. Planograms may be developed for a variety of retail merchandising displays (such as shelf displays, pegboards, or slatboards, clothing racks and the like). Planograms are developed using other information about products, such as the amount of inventory left for the product, volume of sales per square foot of retail space, and other specific information about products (such as stock keeping unit numbers, product codes, and the like). In one embodiment, a state-of-the-shelf simulation may help interested parties develop and support recommendations for the number of facings a certain product should have on a retail display, how high or low the certain product should be on the display, as well as which products should surround the certain product.

Product sales data 233 may indicate how frequently units of a particular product are sold. That is product sales data 233 provides a sales rate for products included in a state-of-the shelf simulation. In one embodiment, the product sales data may be tied to the actual sales made by a particular retail location over a specified period of time (e.g., some period of minutes, hours, days, weeks, etc.) for a given product, group of products, or product category. Product sales data 233 may also represent a composite sales rate for a given product at multiple retail locations. Alternatively, in the context of non-retail “shelf-spaces,” product sales data 233 may represent the consumption rate for inventory items stored on a shelf. For example, product sales data 233 may represent the consumption of medical supplies from a supply room of a hospital stocked with commonly used items.

In one embodiment, simulation data 126 may also be obtained using from smart/shelf product data 235 using “smart shelf” technology. In the retail sales context, a “smart shelf” may be equipped with an RFID tag reader. In turn, inventory units of a product on the “smart shelf” may each be marked with an RFID tag. In such a case, the “smart shelf” may be configured to identify when goods marked with an RFID tags are moved from one location in a shelf-space to another, as well as when inventory levels and an out-of-stock event occurs.

Simulation 126 data may further include shelf stocking data 237. Where store layout data 231 specifies a selection and arrangement of items stored in a shelf-space, and product sales and/or smart shelf/product data 235 specifies how and when items are removed from the shelf, shelf stocking data 237 specifies how/when items are returned or re-stocked on the shelf. For example, shelf stocking data may indicate scheduled stock times based on employee schedules or on product delivery schedules.

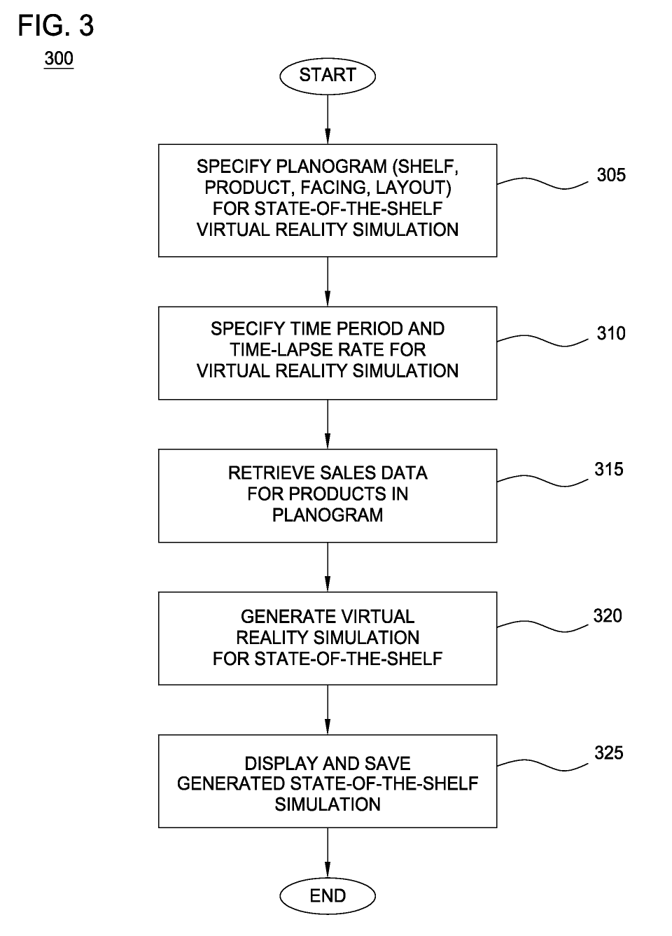

FIG. 3 is a flow chart illustrating a method 300 for conducting a state-of-the-shelf-analysis, according to one embodiment of the invention. The method 300 begins at step 305 where a collection of simulation data is specified for a particular state-of-the shelf simulation. For example, a user may specify a planogram representing a shelf and product layout for a particular retail space. At step 310, a user may specify a time period and time-lapse rate for the state-of-the-shelf analysis. At step 315, the virtual reality simulation generator 130 may be configured to retrieve sales data for the products included in the planogram layout specified at step 305. Using the simulation parameters specified at steps 305, 310, and 315, virtual reality simulation generator 130 may be configured to generate a state-of-the-shelf virtual reality simulation at step 320. At step 325, the state-of-the-shelf virtual reality simulation generated at step 320 may be presented to a user on a virtual reality display platform (e.g., one of the platforms illustrated in FIG. 2). The display may also be saved for later display. For example, a product manufacturer may generate a set of state-of-the-shelf simulations to demonstrate to a retailer how changes to the shelf space dedicated to a given product may be expected to impact product sales, or to identifying or curing out-of-stock events for that product. Thus, state-of-the-shelf simulations may be generated to simulate a broad variety of shelf-space events.

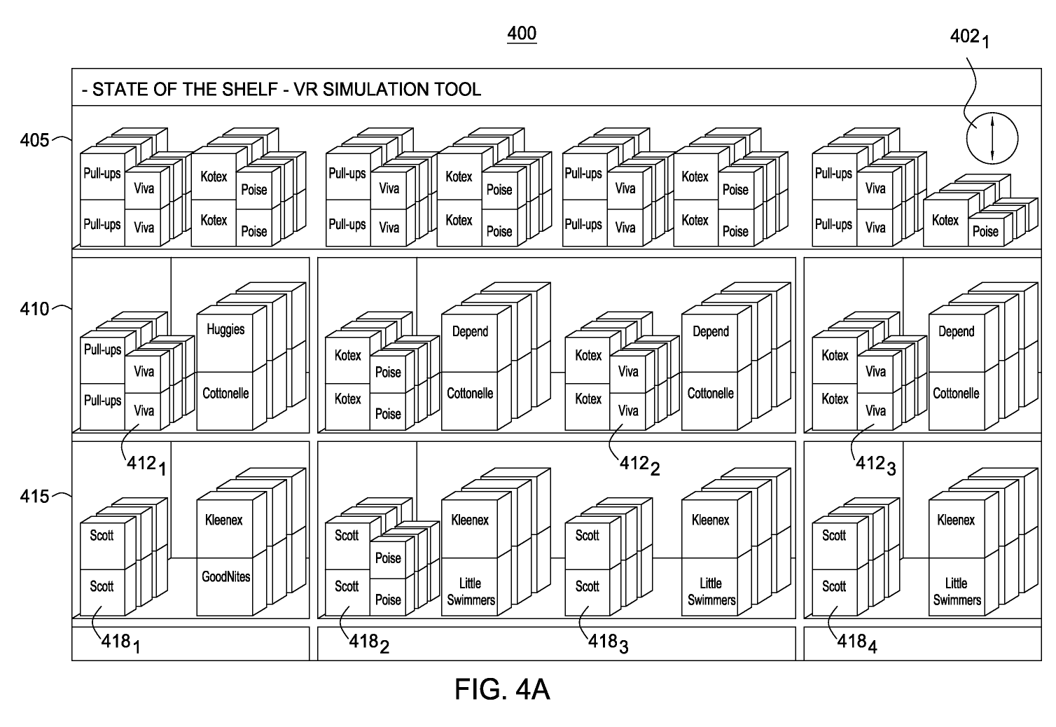

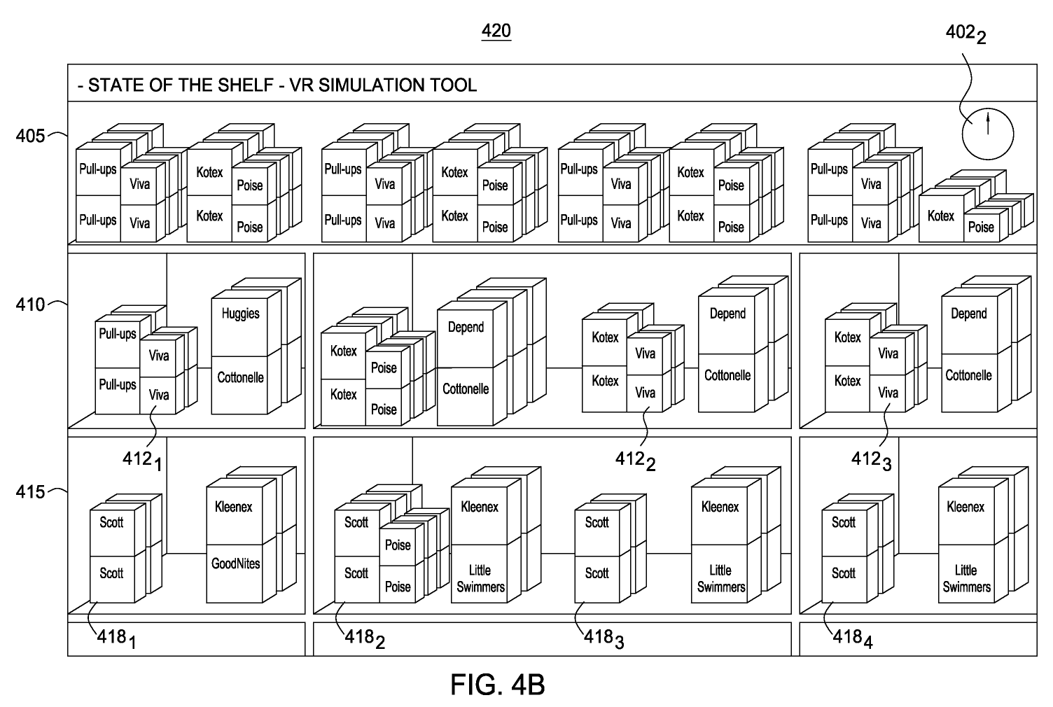

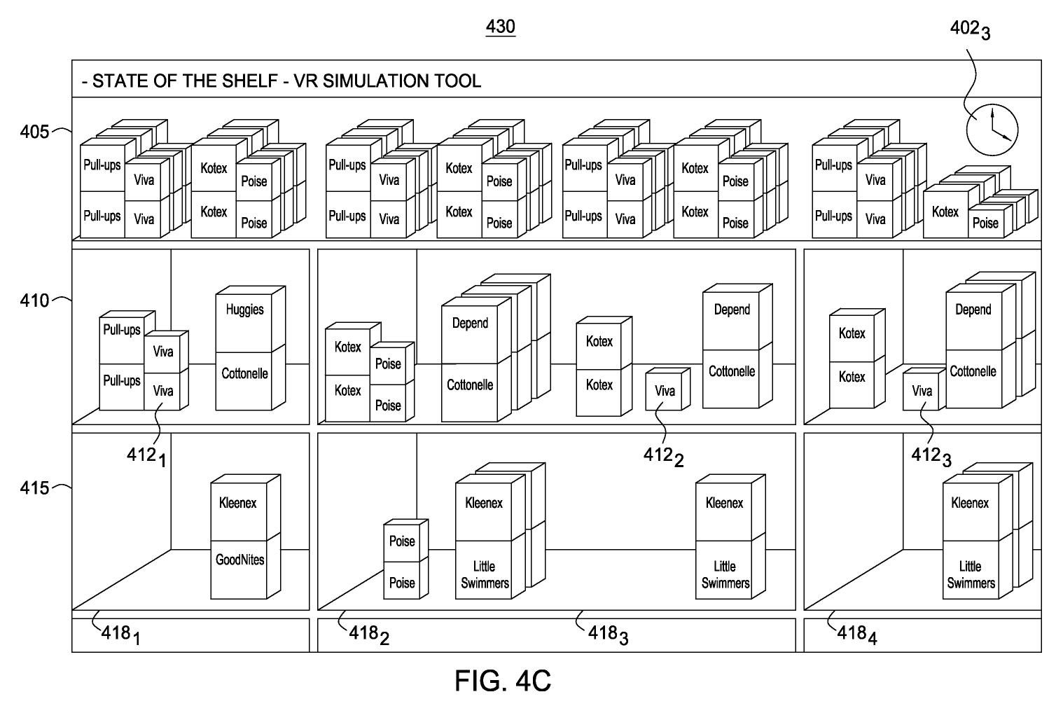

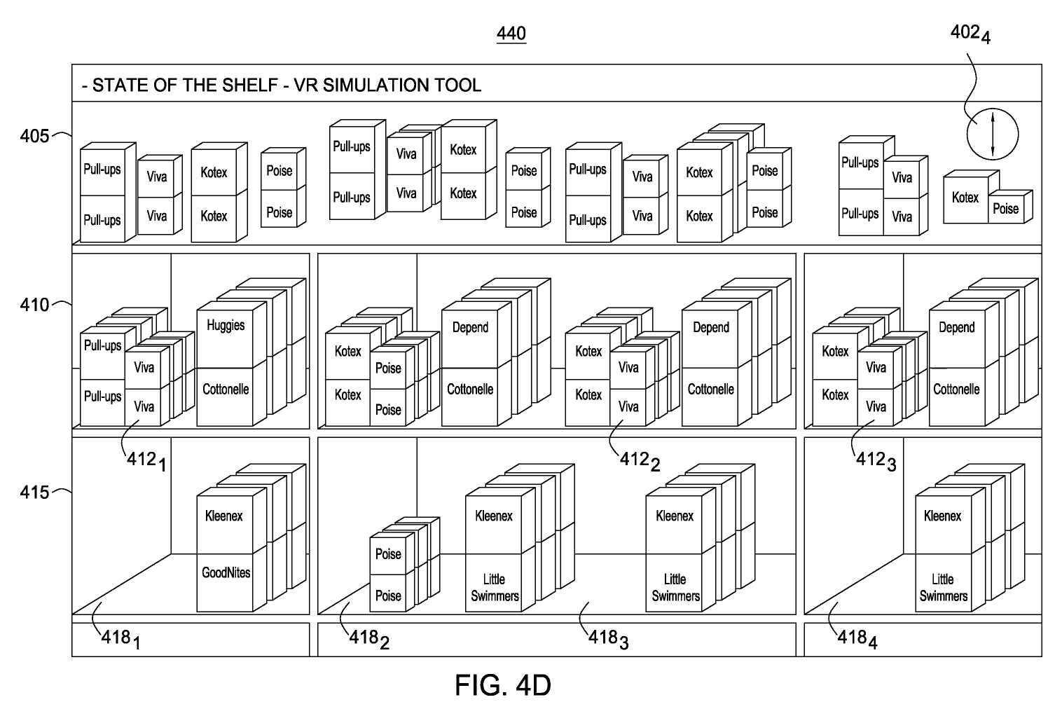

FIGS. 4A-4D illustrate an example state-of-the-shelf virtual reality simulation, according to one embodiment of the invention. Although FIGS. 4A-4D illustrate a collection of state-of-the-shelf snapshots for an example “shelf-space,” the simulation generator may be configured to generate a dynamic multi-media sequence showing the state-of-the-shelf as it changes over time. The user may also configure how such a virtual reality sequence is presented to an observer. For example, characteristics such as speed, (e.g., 0.2×, 3×, 4×, etc.) may be adjusted or a user may stop, pause, fast-forward, and rewind a state-of-the-shelf virtual reality sequence as desired.

In this example, the state-of-the-shelf simulation provides a visualization of the shelves of a retailer that stock a variety of personal care consumer products. As described, the particular selection and arrangement of products may be based on a planogram developed by the retailer. FIGS. 4A-4D provide four “snapshots” of a state-of-the-shelf simulation at four individual points in time. Thus, these figures are representative of a time-lapse animation sequence showing the state of the shelf as it changes over a given time period.

FIG. 4A illustrates an initial state-of-the-shelf 400, at a time index 402₁. As shown, the shelves are fully stocked according to the planogram for this shelf-space. In this example, the shelf-space includes an upper shelf 410 and a lower shelf 415. Additionally, the example shelf-space includes an overstock area 405. The overstock area may be used by a retailer to store inventory in a region generally out of reach by most consumers, and this inventory may be used to periodically replenish the inventory of shelves 410 and 415. Illustratively, upper shelf 410 includes three facings 412₁, 412₂, and 412₃ of Viva® paper towels that store 18 inventory units. Lower shelf 415 includes four facings 418₁, 418₂, 418₃, and 418₄ of Scott® paper towels that store 24 inventory units. Shelves 410 and 415 also show a number of other personal care consumer products.

FIG. 4B illustrates a subsequent state-of-the-shelf 420 at time index 402₂. In this example, six hours have elapsed from the time index 402₁. As shown, facings 412₁, 412₂, and 412₃ of Viva® paper towels now include fewer units of inventory, as some of this product has been sold (as indicated by product sales data 233). The inventory of Scott® paper towels at facings 418₁, 418₂, 418₃, and 418₄ has also been depleted through consumer sales. Specifically, 12 inventory units of Viva® paper towels remain and 18 units of Scott® paper towels remain on shelves 410 and 415.

FIG. 4C illustrates a subsequent state-of-the-shelf 430 at time index 402₃. In this example, four hours have elapsed from the time index 402₂. By the time of time index, 402₃ an out-of-stock event has occurred. That is, no inventory units of Scott® paper towels remains in facings 418₁, 418₂, 418₃, or 418₄. Although additional units of Viva® paper towels have been sold from facings 412₁, 412₂, and 412₃, four inventory units remain. Further, overstock area 405 includes additional inventory of Viva® paper towels to restock this item.

FIG. 4D illustrates a subsequent state-of-the-shelf 440 at time index 402₄. In this example, two hours have elapsed from the time index 402₃. Specifically, state-of-the-shelf 440 shows upper shelf 410 and lower shelf 415 having been replenished using inventory from overstock area 405. Thus, facings 412₁, 412₂, and 412₃ of Viva® paper towels have been replenished to a fully stocked state. In contrast, no inventory is available to replace Scott® paper towels remains in facings 418₁, 418₂, 418₃, or 418₄. From this example, it is readily apparent that it is appropriate for a retailer to carry additional inventory of Scott® paper towels. Further, the 24 units Scott® paper towels has sold-out despite having 6 more units than the Viva® paper towels. Advantageously, a product manufacturer may be able to use this type of information readily visualized in a state-of-the-shelf simulation to persuade the retailer to increase the facings given to Scott® paper towels and reduce the facings of Viva® paper towels from three to two. In such case, the two facings of Viva paper towels would support sale of the 14 inventory units between stocking events, while allowing additional units of Scott® paper towels to be stocked, and presumably, at least some of these units would be sold.

Thus as described, embodiments of the invention employ virtual reality techniques configured to provide an virtual reality visualization of a “state-of-the-shelf” for a given product or item, as the inventory on the shelf is consumed (and, in some cases, replenished) over a period of time. Additionally, the state-of-the-shelf virtual reality techniques described herein may be used to generate any number of alternative scenarios based on a set of product layout and sales rate data. For example, the sales rate of Scott® paper towels from may be used to generate an alternative simulation where the Scott® paper towels are restocked at 4:00 (i.e., at the time illustrated in FIG. 4C) to predict how many actual sales were actually lost due to the out-of-stock event. Further, the virtual reality simulation may include textual or graphical data superimposed on the virtual reality display. For example, the available units of a given product stocked on a shelf may be displayed. While this kind of conventional data by itself may be difficult to interpret, these features may readily be conveyed by using a virtual reality environment.

While the foregoing is directed to embodiments of the present invention, other and further embodiments of the invention may be devised without departing from the basic scope thereof, and the scope thereof is determined by the claims that follow.

What is claimed is:

1. A method of generating a virtual reality simulation of a state of a shelf-space, comprising:
generating a state-of-the-shelf virtual reality simulation for a given layout of the shelf-space based on sales rate data indicating when purchasable items stored in the shelf-space are removed from the shelf-space during a specified time period, wherein the layout defines a selection and arrangement for a set of one or more of the purchasable items stored in the shelf-space and wherein the state-of-the-shelf virtual reality simulation provides a visualization of changes to the shelf-space over the specified time-period based at least in part on the sales rate data.

2. The method of claim 1, wherein the given layout of the shelf-space is a planogram defining a selection and arrangement for a set of retail products occupying a retail merchandising display.

3. The method of claim 1, wherein the sales rate data corresponds to point-of-sale data obtained for a single location of a retail store.

4. The method of claim 1, wherein the sales rate data corresponds to point-of-sale data obtained for multiple locations of a retail store.

5. The method of claim 1, wherein the sales rate data corresponds to forecasted sales data obtained for one or more locations of a retail store.

6. The method of claim 1, wherein the sales rate data includes data obtained from a smart-shelf.

7. The method of claim 1, wherein the state-of-the-shelf virtual reality simulation provides a visualization of out-of-stock events that occur during the specified time period.

8. The method of claim 1, wherein the set of one or more items comprise consumer products.

9. The method of claim 1, wherein the set of one or more items comprise an inventory of medical supplies, and wherein the shelf-space corresponds to shelves storing the inventory of medical supplies at a location providing health-care services.

10. The method of claim 1, wherein the sales rate data further indicates stocking data specifying when a stocking event occurs during the time period to replenish the items removed from the shelf-space.

11. The method of claim 1, wherein the state-of-the-shelf virtual reality simulation is presented to a user in an immersive virtual reality environment.

12. The method of claim 11, wherein the immersive virtual reality environment is a virtual reality cube.

13. The method of claim 1, wherein the state-of-the-shelf virtual reality simulation is presented to a user using one of a PC workstation display, a laptop display, and a head mounted display worn by the user.

14. A computer readable storage medium containing a program which, when executed, performs an operation for generating a virtual reality simulation of a state of a shelf-space, comprising:
generating a state-of-the-shelf virtual reality simulation for a given layout of the shelf-space based on sales rate data indicating when purchasable items stored in the shelf-space are removed from the shelf-space during a specified time period, wherein the layout defines a selection and arrangement for a set of one or more of the purchasable items stored in the shelf-space and wherein the state-of-the-shelf virtual reality simulation provides a visualization of changes to the shelf-space over the specified time-period based at least in part on the sales rate data.

15. The computer readable storage medium of claim 14, wherein the given layout of the shelf-space is a planogram defining a selection and arrangement for a set of retail products occupying a retail merchandising display.

16. The computer readable storage medium of claim 14, wherein the sales rate data corresponds to point-of-sale data obtained for a single location of a retail store.

17. The computer readable storage medium of claim 14, wherein the sales rate data corresponds to point-of-sale data obtained for multiple locations of a retail store.

18. The computer readable storage medium of claim 41, wherein the sales rate data corresponds to forecasted sales data obtained for one or more locations of a retail store.

19. The computer readable storage medium of claim 14, wherein the sales rate data includes data obtained from a smart-shelf.

20. The computer readable storage medium of claim 14, wherein the state-of-the-shelf virtual reality simulation provides a visualization of out-of-stock events that occur during the time period.

21. The computer readable storage medium of claim 14, wherein the set of one or more items comprise consumer products.

22. The computer readable storage medium of claim 14, wherein the set of one or more items comprise an inventory of medical supplies, and wherein the shelf-space corresponds to shelves storing the inventory of medical supplies at a location providing health-care services.

23. The computer readable storage medium of claim 14, wherein the sales rate data further indicates stocking data specifying when a stocking event occurs during the time period to replenish the items removed from the shelf-space.

24. The computer readable storage medium of claim 14, wherein the state-of-the-shelf virtual reality simulation is presented to a user in an immersive virtual reality environment.

25. The computer readable storage medium of claim 24, wherein the immersive virtual reality environment is a virtual reality cube.

26. The computer readable storage medium of claim 14, wherein the state-of-the-shelf virtual reality simulation is presented to a user using one of a PC workstation display, a laptop display, and a head mounted display worn by a user.

27. A system, comprising:
a computing device; and
a memory storing a virtual reality tool, wherein the virtual reality tool is configured to:
generate a state-of-the-shelf virtual reality simulation for a given layout of a shelf-space based on sales rate data indicating when purchasable items stored in the shelf-space are removed from the shelf-space during a specified time period, wherein the layout defines a selection and arrangement for a set of one or more of the purchasable items stored in the shelf-space and wherein the state-of-the-shelf virtual reality simulation provides a visualization of changes to the shelf-space over the specified time-period based at least in part on the sales rate data.

28. The system of claim 27, wherein the given layout of the shelf-space is a planogram defining a selection and arrangement for a set of retail products occupying a retail merchandising display.

29. The system of claim 27, wherein the sales rate data corresponds to point-of-sale data obtained for a single location of a retail store.

30. The system of claim 27, wherein the sales rate data corresponds to point-of-sale data obtained for multiple locations of a retail store.

31. The system of claim 27, wherein the state-of-the-shelf virtual reality simulation provides a visualization of out-of-stock events that occur during the time period.

32. The system of claim 27, wherein the set of one or more items comprise consumer products.

33. The system of claim 27, wherein the sales rate data further indicates stocking data specifying when a stocking event occurs during the time period to replenish the items removed from the shelf-space.

34. The system of claim 33, wherein the state-of-the-shelf virtual reality simulation is presented to a user in an immersive virtual reality environment.

35. The system of claim 34, wherein the immersive virtual reality environment is a virtual reality cube.

36. The system of claim 33, wherein the state-of-the-shelf virtual reality simulation is presented to a user using one of a PC workstation display, a laptop display, and a head mounted display worn by a user.

37. A method for a product manufacturer to manage a relationship with a retailer selling one or more products manufactured by the product manufacturer, comprising:
identifying a selection of a layout for a shelf-space used to display the one or more products manufactured by the product manufacturer for sale;
identifying a selection of a time period for a state-of-the-shelf virtual reality simulation,
obtaining sales rate data indicating when items stored in the shelf-space are removed from the shelf-space during the time period;
generating a state-of-the-shelf virtual reality simulation, wherein the state-of-the-shelf virtual reality simulation provides a visualization of changes to the shelf-space based on the sales rate data as changes occur over the time-period specified for the virtual reality simulation; and
presenting the virtual reality simulation to a representative of the retailer.
